(19) United States
(12) Patent Application Publication
(10) Pub. No.: US 2020/0289980 A1
(43) Pub. Date: Sep. 17, 2020

(54) AIR CLEANSING SYSTEM

(71) Applicant: Chung Yuan Christian University, Taoyuan City (TW)

(72) Inventors: Ya-Fen WANG, Taoyuan City (TW); Sheng-Jie YOU, Taipei City (TW); Qing-Shun CHEN, Taipei City (TW)

(73) Assignee: Chung Yuan Christian University, Taoyuan City (TW)

(21) Appl. No.: 16/299,231

(22) Filed: Mar. 12, 2019

(51) Int. Cl. B01D 53/76; B01D 53/72; B01D 53/14

(52) U.S. Cl. CPC B01D 53/76; B01D 53/14; B01D 53/72

(57) ABSTRACT

Disclosed herein is an air cleansing system including an air supplying device and an air cleansing device. The air supplying device is configured to deliver an airflow that contains pollutants therein into the air cleansing device. The air cleansing device comprises an electric generator, which is configured to generate an electrical energy from the airflow. The air cleansing device also comprises an ozone generator, which is driven by the electrical energy and is configured to produce ozone to cleanse the airflow via removing the pollutants therefrom. The air cleansing device is substantially operated without utilizing any additional electrical energy supplied from outside the air cleansing system; and the airflow is substantially cleansed without utilizing any pollutant trapping material to remove the pollutants from the airflow.

### BACKGROUND OF THE INVENTION

### 1. Field of the Invention

The present disclosure in general relates to the field of air cleansing systems. More particularly, the present disclosure relates to an air cleansing system that producing ozone to cleanse the pollutants contained in airflow.

### 2. Description of Related Art

Sewage treatment is the process of removing contaminants from municipal wastewater produced due to human activities. A variety of microorganisms including aerobic and anaerobic organisms are involved in the breakdown process of organic matter during the sewage treatment, which produces biogases and toxic chemicals. In order to remove the harmful compounds, wet scrubbers are widely used and typically built in a sewage treatment plant. Wet scrubbers are designed to remove a variety of pollutants from exhaust gases before they are released into the environment via the contact of target pollutants or compounds with scrubbing solutions (includes water mist and/or chemical liquids which are able to react with certain target compounds) in a chamber. Eventually, target pollutants or compounds are collected by liquid sprayed through for specialized disposal and further treatment, and the cleaned gases are expelled through the outlet of the wet scrubber.

Despite the functional gain of the wet scrubber, the efficiency of preventing the pollutants from entering the environment gradually decrease if the entire machine is not properly or frequently maintained. A considerable degree of odor matters may be expelled, which causes trouble for neighboring residents. In addition, the process of sewage treatment consumes great amount of energy, which does not meet the modern demand for energy efficiency.

In view of the foregoing, there exists in the related art a need for an improved system for cleaning the exhaust gases while minimizing the energy consumption.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

As embodied and broadly described herein, the present disclosure aims to provide an improved cleansing system with a self-powered device for cleansing exhausted gases while minimizing the energy consumption.

Accordingly, one aspect of the disclosure is directed to an air cleansing system comprising an air supplying device and an air cleansing device. The air supplying device of the air cleansing system is configured to deliver an airflow that contains pollutants therein into the air cleansing device; and the air cleansing device comprises an electric generator and an ozone generator. The electric generator is configured to generate an electrical energy from said airflow; and the ozone generator is driven by the electrical energy and is configured to produce ozone to cleanse said airflow via removing the pollutants therefrom.

According to embodiments of the present disclosure, the air cleansing device is substantially operated without utilizing any additional electrical energy supplied from outside the air cleansing system; and the airflow is substantially cleansed without utilizing any pollutant trapping material to remove the pollutants from the airflow.

In some optional embodiments, the air cleansing device further comprises a container configured to receive the airflow from the air supplying device, and to house the ozone generated from the ozone generator. In these embodiments, the ozone housed in the container has a concentration about 300 ppm to 490 ppm.

According to some embodiments of the present disclosure, the air supplying device is a wet scrubber or a dry scrubber.

According to preferred embodiments of the present disclosure, the airflow has a speed about 10 m/s to 14 m/s.

According to certain embodiments of the present disclosure, the electric generator is a horizontal axis wind turbine or a vertical axis wind turbine.

According to embodiments of the present disclosure, the ozone generator is an ultraviolet ozone generator, a corona discharge ozone generator, a cold plasma ozone generator or an electrolytic ozone generator.

In some embodiments, the pollutants are composed of at least one compound selected from the group consisting of n-butane, isobutane, n-pentane, isopentane, isoprene, hexene, benzene, toluene, dichlorodifluoromethane, ethanol, trichlorofluoromethane, acetone, dichloromethane, chlorotrifluoromethane, 2-methylpentane, 2-methylhexane, m-Xylene, 1,2,4-trimethylbenzene, isopropanol, methylene chloride and a combination thereof.

In some optional embodiments of the present disclosure, the air cleansing device further comprises an electrical energy storage configured to store the electrical energy generated by the electric generator; and a charge controller connected to the electric generator and the electrical energy storage. In such case, the charge controller is configured to control the charge and discharge from the electric generator or the electrical energy storage. In these embodiments, the electric generator is a direct current (DC) generator.

According to certain examples of the present disclosure, the electrical energy storage has an electric potential about 10 Volt to 15 Volt, and a capacity about 5 Ah to 10 Ah.

According to certain examples of the present disclosure, the electrical energy generated by the electric generator is greater than 0.3 kWh/day.

According to certain examples of the present disclosure, the ozone is produced by the air cleansing system at an efficiency about 5 g/kWh to 150 g/kWh.

By virtue of the above configuration, the air cleansing system of the present disclosure comprises a self-powered air cleansing system, in which the ozone generator is only driven by the electricity converted from the airflow, and the ozone generator produces ozone to cleanse the airflow without utilizing any external electricity, thereby conferring the energy conservation of the present system.

Many of the attendant features and advantages of the present disclosure will becomes better understood with reference to the following detailed description considered in connection with the accompanying drawings.

### BRIEF DESCRIPTION OF THE DRAWINGS

The present description will be better understood from the following detailed description read in light of the accompanying drawings, where:

FIG. 1 is a diagram illustrating an air cleansing system 1 according to first embodiment of the present disclosure; and

FIG. 2 is a diagram illustrating an air cleansing device 22 according to second embodiment of the present disclosure.

In accordance with common practice, the various described features/elements are not drawn to scale but instead are drawn to best illustrate specific features/elements relevant to the present invention. Also, like reference numerals and designations in the various drawings are used to indicate like elements/parts.

### DETAILED DESCRIPTION OF THE INVENTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

### I. Definition

For convenience, certain terms employed in the specification, examples and appended claims are collected here. Unless otherwise defined herein, scientific and technical terminologies employed in the present disclosure shall have the meanings that are commonly understood and used by one of ordinary skill in the art. Also, unless otherwise required by context, it will be understood that singular terms shall include plural forms of the same and plural terms shall include the singular. Specifically, as used herein and in the claims, the singular forms “a” and “an” include the plural reference unless the context clearly indicates otherwise. Also, as used herein and in the claims, the terms “at least one” and “one or more” have the same meaning and include one, two, three, or more.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about”. Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques.

The term “pollutants” used herein refers to any substance in the air where is not supposed to be and that can have adverse effects on humans and the ecosystem. The substance can be solid particles, liquid droplets, or gases. In the present disclosure, the pollutants specifically refer to odor chemical compounds such as volatile organic compounds (VOCs) produced during the sewage treatment. Exemplary VOCs includes n-butane, isobutane, n-pentane, isopentane, isoprene, hexene, benzene, toluene, dichlorodifluoromethane, ethanol, trichlorofluoromethane, acetone, dichloromethane, chlorotrifluoromethane (R-13), 2-methylpentane, 2-methylhexane, m-Xylene, 1,2,4-trimethylbenzene, isopropanol, and methylene chloride.

The term “pollutant trapping material” used herein refers to any material that can trap, capture, absorb or react with pollutants in the environment via physical or chemical means. The pollutant trapping material commonly utilized in cleansing systems includes various forms and textures. For instance, the exemplary means of trapping pollutants include, but are not limited to, textile filters made of fiberglass, polypropylene, polyurethane foam, activated carbon or cotton; electrostatic dust collector composed of metals (e.g. silver ion, cobalt ion, and nickel ion, etc.); photocatalyst (e.g., TiO₂, GaP, and GaAs); and ionic air molecules (for instance N₂⁻ or O₂⁻) produced via high voltage.

### II. Description of the Invention

The invention aims at providing an air cleansing system with a self-powered device for cleansing exhausted gases while minimizing the energy consumption.

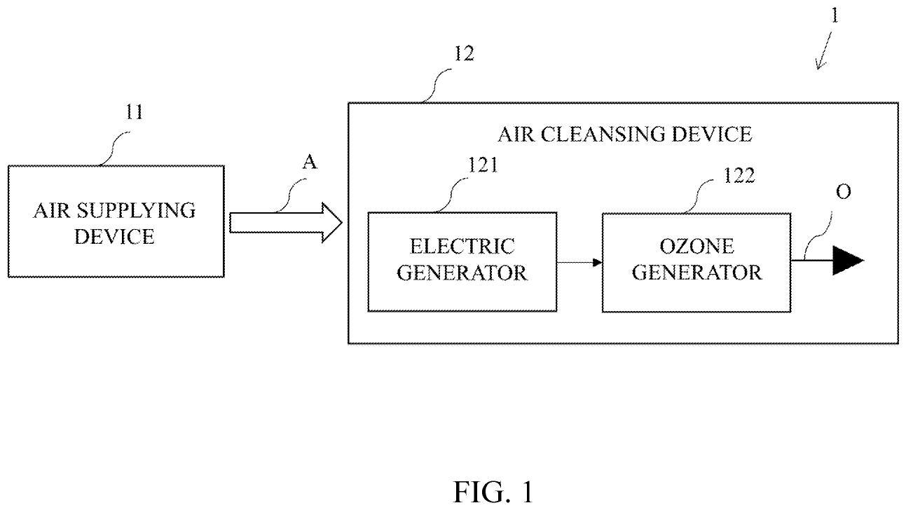

Accordingly, the first aspect of the present disclosure is directed to an air cleansing system 1. Referring to FIG. 1, in which an air cleansing system 1 is depicted. The air cleansing system 1 comprises an air supplying device 11 and an air cleansing device 12. The air supplying device 11 is configured to generate and deliver an airflow (denoted as “A” in FIG. 1) into the air cleansing device 12. In the exemplary implementation, the airflow can be actively/passively created via mechanical means (e.g., fan, turbine or air pump) in the air supplying device 11, and subsequently being directed into the air cleansing device 12. In some embodiments, the air supplying device 11 may be flues, scrubbers, exhaust vents, or exhaust pipes, but not limited thereto. In the preferred embodiment, the present air supplying device 11 is a scrubber (including a wet scrubber or a dry scrubber); and the gas is expelled actively via the airflow (or wind) created by a fan of an air pump disposed therein. The conventional configuration of a scrubber is well-known in the art, thus is omitted herein for the sake of brevity. In some embodiments, the airflow is discharged from the scrubber at a speed about 10 m/s to 14 m/s, preferably about 10.1 m/s to 13 m/s, and more preferably about 10.5 m/s to 12.9 m/s.

It is worth noting that, the airflow provided by the air supplying device 11 contains pollutants. According to embodiments of the present disclosure, the pollutants move with the airflow as an exhaust gas. Typically, the pollutants in the airflow comprise gas phases substances, such as carbon oxides (COx; wherein x is an integer ranging between 1 and 2), sulfur oxides (SxOy; wherein x is an integer ranging between 1 and 7; and y is an integer ranging between 1 and 3), nitrogen oxides (NOx; wherein x is an integer ranging between 1 and 2) and volatile organic compounds (VOCs); and solid or liquid substances, e.g., particles. According to some embodiments of the present disclosure, the pollutants in the exhaust gases provided by the air supplying device 11 comprise VOCs, which typically are odor matters. Examples of VOC include, but are not limited to, n-butane, isobutane, n-pentane, isopentane, isoprene, hexene, benzene, toluene, dichlorodifluoromethane, ethanol, trichlorofluoromethane, acetone, dichloromethane, chlorotrifluoromethane (R-13), 2-methylpentane, 2-methylhexane, m-Xylene, 1,2,4-trimethylbenzene, isopropanol, and methylene chloride.

The air cleansing device 12 is disposed downstream of the air supplying device 11. In some optional embodiments, the air supplying device 11 and the air cleansing device 12 can be physically connected to each other via pipes or air passages that guide the airflow into the air cleansing device 12. In certain embodiments, the air cleansing device 12 is disposed at a distance from the air supplying device 11 without being physically connected. Preferably, the air cleansing device 12 and the air supplying device 11 are not distanced from each other for more than 1.2 meters, such as no more than 1.1, 1, 0.9, 0.8, 0.7, 0.6, 0.5, 0.4, 0.3, 0.2, or 0.1 meters. Alternatively, the air supplying device 11 and the air cleansing device 12 are adjacent to each other without any space there between. In some embodiments, the air supplying device 11 and the air cleansing device 12 are not distanced from each other for more than 1 meter. In certain preferred embodiment, the air supplying device 11 and the air cleansing device 12 are not distanced from each other for more than 70 centimeters.

The air cleansing device 12 comprises an electric generator 121 and an ozone generator 122. The electric generator 121 is configured to generate an electrical energy from said airflow provided by the air supplying device 11. In some embodiments, the electric generator 121 is disposed next to an inlet (not depicted) of the air cleansing device 12. When in operation, the airflow from the air supplying device 11 enters the air cleansing device 12 through the inlet and then to the electric generator 121, which is activated by the passing airflow, thereby generates electrical energy. Preferably, the electric generator 121 is a wind energy convertor, which converts the kinetic energy of the wind into electric energy. Examples of the wind energy convertor includes, but is not limiting to, a horizontal axis wind turbine and a vertical axis wind turbine. In the preferred embodiment, the electric generator 121 is the horizontal axis wind turbine. According to the present disclosure, the electrical energy generated by the electric generator is greater than 0.3 kWh/day, or preferably, greater than 0.35 kWh/day.

Still referring to FIG. 1, the ozone generator 122 is configured to produce ozone (denoted as “O” in FIG. 1) to remove the pollutants existing in the airflow, thereby cleansing the airflow sent from the air supplying device 11. According to the present disclosure, the ozone generator 122 is electrically connected to the electric generator 121 and is driven by electrical energy produced therefrom. In some embodiments, the ozone generator 122 turns regular air (especially oxygen and water molecules) into ozone, which reacts with VOCs and subsequently results in the degradation of VOCs and cleanses the exhaust gases provided from the air supplying device 11. The ozone can be generated or synthesized in accordance with any chemical reaction and principle known in the art. The exemplary ozone generator includes, but is not limited to, an ultraviolet ozone generator, a corona discharge ozone generator, a cold plasma ozone generator and an electrolytic ozone generator. In one preferred embodiment, the ozone generator is the corona discharge ozone generator. Since the ozone generator 122 is driven by the electrical energy produced by the electric generator 121, the ozone production efficiency of the air cleansing system 1 can be calculated as the ratio of the total amount of ozone yield to the total amount of power generation within 24 hours. According the present embodiment, the air cleansing system 1 has an ozone production efficiency about 5 to 150 g/kWh, such as 5, 10, 15, 20, 25, 30, 35, 40, 45, 50, 55, 60, 65, 70, 75, 80, 85, 90, 95, 100, 105, 110, 115, 120, 125, 130, 135, 140, 145 and 150 g/kWh. In one preferred embodiment, the efficiency is about 10 g/kWh. In another preferred embodiment, the efficiency is about 146 g/kWh.

In short, the electric generator 121 of the air cleansing device 12 converts the airflow into electrical energy, and the ozone generator 122 driven exclusively by the thus produced electrical energy produces sufficient amount of ozone to remove existing pollutants in the airflow. Therefore, the air cleansing device 12 of the present disclosure can be said to be a self-powered or self-sustainable device since it only consumes the produced energy of its own. By this configuration, the air cleansing device 12 of the present disclosure is substantially operated without utilizing any additional electrical energy supplied from outside the air cleansing system 1.

It should be notated that the airflow delivered into the air cleansing device 12 is substantially cleansed only by ozone. Generally, many substances (e.g., activated carbon, silver ion, and anions) that embraces cleansing ability via physical principle or chemical reaction can be utilized as pollutant trapping materials in the conventional air cleansing systems. However, the air cleansing device 12 of the present disclosure does not contain or produce any said pollutant trapping materials, such that the airflow delivered therein is substantially cleansed without utilizing any pollutant trapping material to remove the pollutants from the airflow. In other words, the air purification effects of the air cleansing device 12 of present disclosure can be achieved with only the ozone (O₃) molecule. Hence, the air cleansing system 1 of the present disclosure can achieve maximal air cleansing effects with minimal energy consumption.

According to the other embodiments of the present disclosure, an alternative configuration of the air cleansing system is provided. Structurally speaking, the air cleansing system in this embodiment also comprises an air supplying device and an air cleansing device, except the air cleansing device is configured differently.

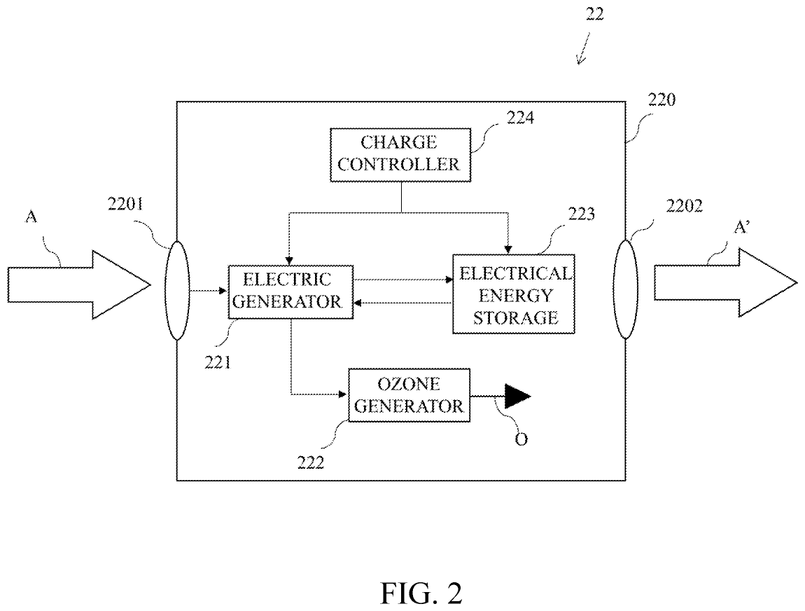

Referring to FIG. 2, which depicts an air cleansing device 22 according to another embodiment of the present disclosure. The air cleansing device 22 is constituted by at least, an electric generator 221, an ozone generator 222, an electrical energy storage 223 and a charge controller 224, which are all housed in a container 220. Further, an inlet 2201 and an outlet 2202 are respectively created on the walls of the container 220 to receive an airflow (denoted as A in FIG. 2) from the ambient environment or from an air supplying device described above (not depicted in FIG. 2) and to discharge air that has been cleansed by the air cleansing device 22 (denoted as A′ in FIG. 2). In practice, the electric generator 221 of the present disclosure (i.e., a wind turbine) is disposed downstream to the inlet 2201, preferably close to or adjacent to the inlet 2210, such that the electric generator 221 can be immediately activated by the airflow entered through the inlet 2201. The ozone generator 222 is coupled to the electric generator 221 in such manner that the electricity generated from the electric generator 221 may drive the production of ozone from the ozone generator 222. The ozone thus produced, in turn, may degrade any pollutants that comes with the airflow. By this manner, ozone is gradually accumulated in the container 220, in which the degradation of the pollutants increases along with the increases in the accumulated ozone in the container 220. According to embodiments of the present disclosure, the ozone accumulated in the container 220 may be in the range of about 300 to 490 ppm, for example, 300, 310, 320, 330, 340, 350, 360, 370, 380, 390, 400, 410, 420, 430, 440, 450, 460, 470, 480, or 490 ppm. In some preferred embodiments, the accumulated ozone is about 310 to 470 ppm, more preferably, about 332 to 465 ppm; even more preferably, about 398 to 459 ppm. The airflow housed in the container 220 is cleansed after being in contact with the accumulated ozone for a sufficient period of time. The clean air (denoted as A′ in FIG. 2) then leaves the container 220 through the outlet 2202.

According to embodiments of the present disclosure, the container 220 may be made of any well-known materials, including but not limited to, plastics, glasses, polymer resins, woods, etc. In one preferred embodiment, the container 220 is made of transparent acrylics.

Still referring to FIG. 2, the air cleansing device 220 may further comprise an electrical energy storage 223 and a charge controller 224. The electrical energy storage 223 is electrically connected to the electric generator 221 to store the electrical energy produced therefrom. The charge controller 224 is coupled to both the electric generator 221 and the electrical energy storage 223, and is configured to control the charge and discharge of electricity of the electric generator 221 and the electrical energy storage 223. In practice, the electric generator 221 may be a horizontal axis wind turbine as aforementioned, the electrical energy storage 223 may be a battery that has a pre-determined electric potential, and the charge controller 224 may be a wind turbine controller that controls the electrical circuit according to the speed of the entering airflow to avoid over charging the load (i.e., electric potential of a battery) during high winds. Typically, if the charge controller 224 senses that the battery is being over charged, it will reduce the duty cycle, which reduces the charging current between the battery and the electric generator 221. This will also unload the electric generator 221 and cause it to rotate faster. If the electric generator 221 is near the maximum speed, a dump load can be added instead, then the charge controller 224 slows the electric generator 221 and reduces its power production. In one preferred embodiment, the electric generator 221 generates direct current (DC). In other preferred embodiments, the electric potential of the electrical energy storage 223 is 10 Volts to 15 Volts, and the capacity thereof is 5 Ah to 10 Ah.

It is worth noting that, since the aim of the present disclosure is to minimize the energy consumption, the charge controller 224 is exclusively driven by electrical energy produced by the electric generator 221; in other words, all elements included in the air cleansing device 22 are not powered by any external electricity.

By virtue of the above configuration, the present air cleansing system of the present disclosure achieves the purpose of cleansing the exhaust gases via utilizing the electric power efficiently and confers the energy conservation.

The following Examples are provided to elucidate certain aspects of the present invention and to aid those of skilled in the art in practicing this invention. These Examples are in no way to be considered to limit the scope of the invention in any manner. Without further elaboration, it is believed that one skilled in the art can, based on the description herein, utilize the present invention to its fullest extent. All publications cited herein are hereby incorporated by reference in their entirety.

### EXAMPLE

### Example 1 Constructing Air Cleansing Device

A transparent acrylic box (size: 30 cm×40 cm×45 cm) was provided to house the air cleansing device and to accommodate air. Two openings were respectively made on left and right sides of the box to serve as an inlet and an outlet of air. A horizontal axis wind turbine was disposed next to the inlet. In addition, a wind turbine controller (including a 50 W resistor, 3424D110, HOPOOL), a battery (GTX7A-Bs, GS battery), and a ceramic corona discharge ozone generator (DC12V2gC, Shengyao) were disposed in the acrylic box. The detail specification of each elements are listed as follows.

Horizontal axis wind turbine,
Rated voltage: DC 12-120 V
Rated power: 50 W
Weight: 411 g
Rated speed: 1000-3000 rpm
Rotor Diameter: 27.5 cm

Wind turbine controller,
Rated voltage: 12 V
Maximum current output: 15 A
Standby current: 2 mA
Cutoff voltage: 14 V
Dimensions: 70×110×35 mm³

Battery,
Output voltage: 12 V
Current: 6 A
Sizes: 151×88×91 mm

Ceramic corona discharge ozone generator,
Ozone output: 33.3 g/min
Ceramic dimensions: 110×50×25 mm³
Output voltage: 2.5-3 kV.

Accordingly, the wind turbine controller was connected to the horizontal axis wind turbine and the battery, and the ceramic corona discharge ozone generator was connected to the horizontal axis wind turbine, therefore the air cleansing device was constructed.

### Example 2 Characterization of the Air Cleansing Device of Example 1

In this example, the air cleansing device of Example 1 was coupled to a wet scrubber of Dihua sewage treatment plant (Taipei, Taiwan), which served as an air supplying device, so as to investigate the electricity generation and ozone production efficiency of the device.

To this purpose, the air cleansing device of Example 1 was disposed at a distance downstream the exhaust vent of the sewage treatment plant, in which an airflow (as a wind) containing volatile organic compounds (VOCs) was discharged from the exhaust vent, where the maximum wind speed measured was 14 m/s, and the average wind speed measured was 12.9 m/s.

The discharged airflow entered the air cleansing device of Example 1 and resulted in electricity production from the horizontal axis wind turbine. The distance between the exhaust vent of the wet scrubber was varied from 0 to 100 centimeters. The produced power by the horizontal axis wind turbine was 9.65 W to 15.39 W. Table 1 lists the correlation among various factors that affects the power efficiency.

TABLE 1
System parameters

| Distance between | Airflow/ | Rotor speed | | Power generated |
|---|---|---|---|---|
| exhaust vent and | wind | of horizontal | Volt- | by horizontal |
| air cleansing | speed | axis wind | age | axis wind |
| device (cm) | (m/s) | turbine (rpm) | (V) | turbine (W) |
| 0 | 12.9 | 1503 | 12.31 | 15.39 |
| 10 | 12.7 | 1501 | 12.20 | 15.13 |
| 20 | 12.5 | 1490 | 12.21 | 14.77 |
| 30 | 12.2 | 1477 | 12.15 | 14.70 |
| 40 | 11.8 | 1433 | 12.06 | 14.47 |
| 50 | 11.6 | 1402 | 11.96 | 13.75 |
| 60 | 11.3 | 1350 | 11.83 | 13.49 |
| 70 | 10.9 | 1300 | 11.76 | 13.17 |
| 80 | 10.4 | 1243 | 11.45 | 12.60 |
| 90 | 10.5 | 1198 | 11.14 | 11.36 |
| 100 | 10.1 | 1132 | 10.38 | 9.65 |

When the air cleansing system started to operate, the ozone generator was only driven by electricity from the wind turbine, as long as the electricity voltage was above 11 V. The air cleansing system did not have any pollutant trapping material other than ozone. The initial yield of ozone was 34 ppm per minute (0.16 g/hour). After 30 minutes of operation, the ozone production reached the plateau phase, and eventually stabilized the output of 459 ppm per minute (2.19 g per hour).

On the other hand, the horizontal axis wind turbine could also work without time limitation, as long as the wet scrubber keeps exhausting airflow, hence the power generation of which can be over 0.3 kWh for 24 hours, even up to 0.36 kWh/day. In such case, efficiency of ozone production of the present air cleansing system, i.e. the ozone yield per unit of power generation, is 10.67 to 146 g/kWh.

### Example 3 the Air Cleansing Efficiency of the Air Cleansing Device of Example 1

In this example, the air cleansing efficiency of the present air cleansing device was investigated via use of airflow containing toluene as the VOCs. The initial concentration of toluene at the beginning (time point=0 min) was 8 ppm in the acrylic box. After reacting with ozone (459 ppm) for 30 minutes, the concentration of remaining toluene was dropped to a low level of 1.24 ppm. The removal rate of organic volatile compound was over 80%.

It can be seen from the above result that ozone produced by the air cleansing device of example 1 has an excellent effect on the removal of VOCs without involving other pollutant trapping materials.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

1. An air cleansing system comprising an air supplying device and an air cleansing device, wherein,
the air supplying device is configured to deliver an airflow that contains pollutants therein into the air cleansing device; and
the air cleansing device comprises:
an electric generator configured to generate an electrical energy from the airflow; and
an ozone generator driven by the electrical energy and configured to produce ozone to cleanse the airflow via removing the pollutants therefrom,
wherein the air cleansing device is operated without utilizing any additional electrical energy supplied from outside the air cleansing device; and the airflow is cleansed without utilizing any pollutant trapping material to remove the pollutants from the airflow.

2. The air cleansing system of claim 1, wherein the air cleansing device further comprises a container configured to receive the airflow from the air supplying device, and to house the ozone generated from the ozone generator.

3. The air cleansing system of claim 2, wherein the ozone housed in the container has a concentration about 300 ppm to 490 ppm.

4. The air cleansing system of claim 1, wherein the air supplying device is a wet scrubber or a dry scrubber.

5. The air cleansing system of claim 1, wherein the airflow has a speed about 10 m/s to 14 m/s.

6. The air cleansing system of claim 1, wherein the electric generator is a horizontal axis wind turbine or a vertical axis wind turbine.

7. The air cleansing system of claim 1, wherein the ozone generator is an ultraviolet ozone generator, a corona discharge ozone generator, a cold plasma ozone generator or an electrolytic ozone generator.

8. The air cleansing system of claim 1, wherein the pollutants are composed of at least one compound selected from the group consisting of n-butane, isobutane, n-pentane, isopentane, isoprene, hexene, benzene, toluene, dichlorodifluoromethane, ethanol, trichlorofluoromethane, acetone, dichloromethane, chlorotrifluoromethane, 2-methylpentane, 2-methylhexane, m-Xylene, 1,2,4-trimethylbenzene, isopropanol, methylene chloride and a combination thereof.

9. The air cleansing system of claim 1, wherein the air cleansing device further comprises:
an electrical energy storage configured to store the electrical energy generated by the electric generator; and
a charge controller connected to the electric generator and the electrical energy storage, wherein the charge controller is configured to control the charge and discharge from the electric generator or the electrical energy storage.

10. The air cleansing system of claim 9, wherein the electric generator is a direct current (DC) generator.

11. The air cleansing system of claim 10, wherein the electrical energy storage has an electric potential about 10 Volt to 15 Volt, and a capacity about 5 Ah to 10 Ah.

12. The air cleansing system of claim 1, wherein the electrical energy generated by the electric generator is greater than 0.3 kWh/day.

13. The air cleansing system of claim 1, wherein the ozone is produced by the air cleansing system at an efficiency about 5 g/kWh to 150 g/kWh.

14. (canceled)
